(19) United States
(12) Patent Application Publication
(10) Pub. No.: US 2016/0049639 A1
(43) Pub. Date: Feb. 18, 2016

(54) NONAQUEOUS ELECTROLYTE SECONDARY BATTERY

(71) Applicant: SANYO ELECTRIC CO., LTD., Osaka (JP)

(72) Inventors: Hiroshi Minami, Hyogo (JP); Mai Yokoi, Tokushima (JP); Tatsuya Akira, Hyogo (JP); Naoki Imachi, Hyogo (JP); Taizou Sunano, Hyogo (JP)

(73) Assignee: SANYO ELECTRIC CO., LTD., Daito-shi, Osaka (JP)

(21) Appl. No.: 14/778,758

(22) PCT Filed: Mar. 18, 2014
(86) PCT No.: PCT/JP2014/001536

§ 371 Date: Sep. 21, 2015

(30) Foreign Application Priority Data
Mar. 22, 2013 (JP) 2013-059222
Mar. 28, 2013 (JP) 2013-068548

(51) Int. Cl. H01M 4/131; H01M 4/38; H01M 4/587; H01M 4/134; H01M 4/485

(52) U.S. Cl. CPC H01M 4/131; H01M 4/134; H01M 4/485; H01M 4/587; H01M 4/386; H01M 2004/027

(57) ABSTRACT

In a nonaqueous electrolyte secondary battery using SiOₓ (0<x<2) as a negative electrode active material, cycle characteristics are improved. There is provided a nonaqueous electrolyte secondary battery including a negative electrode active material which contains a substance represented by SiOₓ (0<x<2). In this nonaqueous electrolyte secondary battery, when the value of x in the above general formula is represented by xₛ at a surface of the substance and is represented by x_{b} at a central portion thereof, x_{b}<xₛ holds, and when a depth of the substance from the topmost surface thereof at which x=(xₛ+x_{b})/2 holds is represented by zₐ (μm), and when the average particle diameter of the substance is represented by R (μm), 0.05<zₐ and 0.025≦zₐ/R≦0.4 hold.

### TECHNICAL FIELD

The present invention relates to a nonaqueous electrolyte secondary battery.

### BACKGROUND ART

Since having a high capacity per unit volume as compared to that of a carbon material such as graphite, silicon (Si) and a silicon oxide represented by SiOₓ have been investigated for application to negative electrode active materials. In particular, when Li⁺ is occluded in charge, the volume expansion rate of SiOₓ is smaller than that of Si, and hence, SiOₓ has been expected to be practically employed at an early stage. For example, Paten Document 1 has proposed a nonaqueous electrolyte secondary battery which employs a negative electrode active material formed by mixing SiOₓ with graphite.

### CITATION LIST

### Patent Document

Patent Document 1: Japanese Published Unexamined Patent Application No. 2011-233245

### SUMMARY OF INVENTION

### Technical Problem

However, when a nonaqueous electrolyte secondary battery which uses SiOₓ or the like as a negative electrode active material is compared to that using graphite as a negative electrode active material, a problem in that cycle characteristics are seriously degraded may arise in some cases.

### Solution to Problem

The major reasons of this problem are a larger volume change of SiOₓ or the like in chare/discharge than that of graphite and an increase in irreversible capacity caused by a reaction between SiOₓ and an electrolyte solution.

In order to solve the above problem, a nonaqueous electrolyte secondary battery of the present invention comprises a negative electrode active material which contains a substance represented by a general formula of SiOₓ (0<x<2). In addition, in this nonaqueous electrolyte secondary battery, when the value of x in the general formula is represented by xₛ at a surface and is represented by x_{b} at a central portion, x_{b}<xₛ holds, and when a depth of the substance from the surface thereof at which x=(xₛ+x_{b})/2 holds is represented by zₐ (μm), and the average particle diameter of the substance is represented by R (μm), 0.05<zₐ and 0.025≦zₐ/R≦0.4 hold.

### Advantageous Effects of Invention

According to the present invention, in the nonaqueous electrolyte secondary battery which uses SiOₓ as a negative electrode active material, cycle characteristics can be improved.

### BRIEF DESCRIPTION OF DRAWINGS

FIG. 1 is an electron microscopic image showing a cross-section of a negative electrode active material particle (after 25 cycles) used in Experiment 4.

### DESCRIPTION OF EMBODIMENT

Hereinafter, an embodiment of the present invention will be described in detail. When the term “approximately **” used in this specification is explained using the case of “approximately equivalent” by way of example, the “approximately equivalent” indicates not only the same but also substantially the same.

A nonaqueous electrolyte secondary battery, which is one example of the embodiment of the present invention, includes a positive electrode containing a positive electrode active material, a negative electrode containing a negative electrode active material, and a nonaqueous electrolyte containing a nonaqueous solvent. Between the positive electrode and the negative electrode, at least one separator is preferably provided. As one example of the nonaqueous electrolyte secondary battery, there may be mentioned a structure in which an electrode body formed by winding a positive electrode and a negative electrode with at least one separator interposed therebetween and a nonaqueous electrolyte are received in an exterior package.

### Positive Electrode

The positive electrode is preferably formed of a positive electrode collector and a positive electrode active material layer formed thereon. For the positive electrode collector, for example, a thin film having an electrical conductivity is used, and in particular, there may be used metal foil formed of aluminum or the like which is stable in a potential range of the positive electrode, alloy foil thereof, or a film having a metal surface layer formed of aluminum or the like. The positive electrode active material layer also preferably contains, besides the positive electrode active material, an electrically conductive material and a binder.

Although the positive electrode active material is not particularly limited, a lithium transition metal oxide is preferable. The lithium transition metal oxide may also contain a non-transition metal element, such as Mg or Al. As a concrete example, for example, lithium cobaltate, an olivine type lithium phosphate, such as lithium iron phosphate, and a lithium transition metal oxide, such as Ni-Co-Mn, Ni-Mn-Al, or Ni-Co-Al, may be mentioned. As the positive electrode active material, those materials mentioned above may be used alone, or at least two types thereof may be used in combination.

For the electrically conductive material, for example, a carbon material, such as carbon black, acetylene black, ketjen black, or graphite, or a mixture containing at least two types thereof may be used. For the binder, a polytetrafluoroethylene, a poly(vinylidene fluoride), a poly(vinyl acetate), a polyacrylonitrile, a poly(vinyl alcohol) or a mixture containing at least two types thereof may be used.

### Negative Electrode

The negative electrode preferably includes a negative electrode collector and a negative electrode active material layer formed thereon. For the negative electrode collector, for example, a thin film having an electrical conductivity is used, and in particular, there may be used metal foil formed of copper or the like which is stable in a potential range of the negative electrode, alloy foil thereof, or a film having a metal surface layer formed of copper or the like. The negative electrode active material layer also preferably contains a binder besides the negative electrode active material. As the binder, although a polytetrafluoroethylene or the like may also be used as in the case of the positive electrode, for example, a styrene-butadiene rubber (SBR) or a polyimide is preferably used. The binder may be used together with a thickening agent such as a carboxymethyl cellulose.

For the negative electrode active material, a silicon oxide (SiOₓ) is used. SiOₓ (0<x<2) has a structure in which, for example, Si is dispersed in an amorphous SiO₂ matrix. As the negative electrode active material, although SiOₓ may be used alone, in order to simultaneously achieve an increase in capacity and an improvement in cycle characteristics, SiOₓ is preferably used by mixing with another negative electrode active material having a small volume change by charge/discharge as compared to that of SiOₓ. Although the negative electrode active material having a small volume change by charge/discharge as compared to that of SiOₓ is not particularly limited, a carbon-based active material, such as graphite or hard carbon, is preferable.

In the case in which SiOₓ is used by mixing with another negative electrode active material having a small volume change by charge/discharge as compared to that of SiOₓ, for example, when SiOₓ is used by mixing with graphite, the ratio of SiOₓ to graphite is preferably set to 1: 99 to 20: 80 on the mass basis. If the mass ratio is in the range described above, the increase in capacity and the improvement in cycle characteristics can be simultaneously and easily achieved. On the other hand, if the rate of SiOₓ with respect to the total mass of the negative electrode active material is less than one percent by mass, the advantage of increase in capacity obtained by addition of SiOₓ may be reduced in some cases.

The silicon oxide is represented by a general formula of SiOₓ (0<x<2); when the value of x in the above formula is represented by xₛ at a surface and by x_{b} at a central portion, x_{b}<xₛ holds; and when a depth of SiOₓ from the surface thereof at which x=(xₛ+x_{b})/2 holds is represented by zₐ (μm), and the average particle diameter of SiOₓis represented by R (μm), 0.05<zₐ and 0.025≦zₐ/R≦0.4 hold.

The case in which the value of x of SiOₓsatisfies x_{b}<xₛ indicates that the oxygen concentration at the surface of SiOₓ is higher than that at the central portion thereof. In addition, the case in which 0.05<zₐ holds indicates that the depth of a layer from the surface thereof at which the oxygen concentration is high is larger than 0.05 μm.

za/R is more preferably 0.05 to 0.3. When zₐ/R is small, that is, when the depth of the layer from the surface thereof at which the oxygen concentration is high is excessively small as compared to the particle diameter of SiOₓ, a reaction between SiOₓand an electrolyte solution is liable to occur. When zₐ/R is large, that is, when the depth of the layer from the surface thereof at which the oxygen concentration is high is excessively large as compared to the particle diameter of SiOₓ, a decrease in capacity of the active material caused by oxidation of Si in SiOₓ is liable to occur.

zₐ is more preferably 0.1 to 20 μm, more preferably 0.25 to 10 μm, and further preferably 0.5 to 5.0 μm. When zₐ is excessively small, a reaction between Si in SiOₓ and the electrolyte solution is liable to occur. When zₐ is excessively large, a decrease in capacity of the active material in SiOₓ is liable to occur.

The surface of SiOₓ indicates a portion in contact with the electrolyte when SiOₓ is incorporated in a battery. The central portion of SiOₓ indicates a portion which is not in contact with the electrolyte in the battery and a gravity center of each particle.

xₛ at the surface of SiOₓ indicates the value in a portion from the topmost surface of SiOₓ to a depth of 30 nm toward the central portion. x_{b} at the central portion of SiOₓ indicates the value at a portion at which the value of x of SiOₓ reaches a constant value in the particle.

As for the oxygen concentration of SiOₓ, for example, there may be mentioned the case in which the oxygen concentration of SiOₓ is continuously decreased from the surface of the particle to the inside thereof and the case in which a surface layer having a high oxygen concentration is apparently separated from a central portion having a low oxygen concentration in terms of the oxygen concentration of SiOₓ. The case in which the surface layer having a high oxygen concentration is separated from the central portion having a low oxygen concentration in terms of the oxygen concentration of SiOₓ may also include the case in which in the surface layer and/or the central portion, the oxygen concentration is continuously decreased from the surface to the inside. In the case in which the oxygen concentration of SiOₓ is continuously decreased from the surface of the particle to the inside thereof, for example, when a SEM reflection electron image of a particle cross-section is observed, the brightness is continuously changed from a dark particle surface to a bright central portion. In the case in which the surface layer having a high oxygen concentration is separated from the central portion having a low oxygen concentration in terms of the oxygen concentration of SiOₓ, for example, when a SEM reflection electron image of a particle cross-section is observed, the contrast at a dark surface portion is different from that at a bright central portion.

In the case in which the surface layer having a high oxygen concentration is separated from the central portion having a low oxygen concentration in terms of the oxygen concentration of SiOₓ, the distance from the topmost surface of SiOₓ to a boundary portion between the surface layer having a high oxygen concentration and the central portion having a low oxygen concentration is approximately equivalent to zₐ.

The relationship between the depth (z) of the SiOₓ particle from the surface thereof and the oxygen concentration (x) can be obtained using a secondary ion mass spectroscopic method (SIMS) and high frequency inductive coupled plasma (ICP). The oxygen concentration of bulk SiOₓ can be determined by ICP, and when an operation in which after a predetermined thickness is removed from the surface by an ion etching method, Si and O of a remaining surface are analyzed by SIMS is repeatedly performed, the relationship between z and x can be obtained. Besides the method described above, the relationship between the depth (z) of the SiOₓ particle from the surface thereof and the oxygen concentration (x) can also be obtained in such a way that after the particle is cut using an ion milling method, a composition analysis of a cross-section of the particle is performed using EDS or the like. The oxygen concentration (x) can be calculated from the ratio in intensity of O/Si at the surface of the particle to that at the central portion thereof.

The average particle diameter of SiOₓ is preferably 1 to 30 μm, more preferably 1 to 20 μm, and further preferably 2 to 15 μm. As used herein, the term “average particle diameter” indicates a particle diameter (volume average particle diameter: D₅₀) at a volume integrated value of 50% in particle size distribution measured by a laser diffraction scattering method. Dv₅₀ may be measured, for example, by “LA-750” manufactured by HORIBA Corp. When the average particle diameter of SiOₓ is small, the particle surface area is increased, and hence, the capacity is liable to decrease due to an increase in amount used for the reaction with the electrolyte. On the other hand, when the average particle diameter is large, the amount of change in volume by charge/discharge is liable to increase.

The surface of SiOₓ is preferably covered with an electron conductive material. The electron conductive material is formed of a material having a high electrical conductivity as compared to that of SiOₓ. As the electron conductive material, an electrochemically stable material is preferable, and at least one type selected from the group consisting of a carbon material, a metal, and a metal compound is preferable.

As the carbon material, carbon black, acetylene black, ketjen black, graphite, or a mixture containing at least two types thereof may be used. As the metal, Cu, Ni, or an alloy thereof, each of which is stable at the negative electrode, may be used. As the metal compound, a Cu compound or a Ni compound may be mentioned by way of example.

The coverage of the electron conductive material with respect to the surface of SiOₓ is less than 100% and more preferably 5% to 80%. That is, the surface of SiOₓ is preferably exposed. When the coverage described above is small, the electrical conductivity between SiOₓ particles is liable to decrease. When the coverage described above is large, that is, when the coverage of the electron conductive material is 100%, a side reaction product is generated by a reaction between the electron conductive material and the electrolyte solution and is liable to be deposited on the particles.

The electron conductive material described above is preferably adhered to the surface of SiOₓ.

In order to ensure the electrical conductivity and in consideration of the diffusibility of Li⁺ to SiOₓ and the like, the average thickness of the electron conductive material covering the surface of SiOₓis preferably 1 to 200 nm and more preferably 5 to 100 nm.

As a method for covering the surface of SiOₓ with the electron conductive material, for example, a CVD method, a sputtering method, an electroplating method, an electroless plating method, and a coal pitch method may be used. For example, when a coating film is formed on the surface of each SiOₓ particle by a CVD method using a carbon material, SiOₓ particles and a hydrocarbon gas are heated in a vapor phase, and carbon generated by thermal decomposition of the hydrocarbon gas is deposited on the SiOₓ particles. As the hydrocarbon gas, a methane gas or an acetylene gas may be used.

A region from the surface of SiOₓ to zₐ preferably includes a lithium silicate phase. When the oxygen concentration of the surface of SiOₓ is high, Si in SiOₓ and the electrolyte solution are likely to react with each other, and as a result, a lithium silicate phase is formed. When the region from the surface of SiOₓ to zₐ includes a lithium silicate phase, a subsequent reaction between SiOₓ and the electrolyte solution is suppressed. As the lithium silicate, for example, Li₄SiO₄, Li₂SiO₂, Li₂Si₂O₅, and Li₈SiO₅ may be mentioned.

In a negative electrode active material containing a substance represented by SiOₓ (0<x<2), SiOₓ in which when the value of x in the above general formula is represented by xₛ at a surface and by x_{b} at a central portion, x_{b}<xₛ holds, and when a depth of the substance from the surface thereof at which x=(xₛ+x_{b})/2 holds is represented by zₐ (μm), and the average particle diameter of the substance is represented by R (μm), 0.05<zₐ and 0.025≦zₐ/R≦0.4 hold can be obtained by the following method. A nonaqueous electrolyte secondary battery in which a negative electrode active material containing a substance represented by a general formula of SiOₓ (0<x<2) is used, 5% to 80% of the surface of the above substance is covered with an electron conductive material, and the electron conductive material is adhered to the surface of the substance is charged and discharged for 25 cycles or more.

### Nonaqueous Electrolyte

The nonaqueous electrolyte includes a nonaqueous solvent and an electrolyte salt dissolved therein. The nonaqueous electrolyte is not limited to a liquid electrolyte (nonaqueous electrolyte solution), and a solid electrolyte using a gel polymer or the like may also be used. For the nonaqueous solvent, for example, an ester, an ether, a nitrile (acetonitrile or the like), an amide (dimethylformamide or the like), or a mixed solvent containing at least two types thereof may be used.

As examples of the above ester, for example, there may be mentioned a cyclic carbonate, such as ethylene carbonate (EC), propylene carbonate, or butylene carbonate; a chain carbonate, such as dimethyl carbonate, methyl ethyl carbonate, diethyl carbonate (DEC), methyl propyl carbonate, ethyl propyl carbonate, or methyl isopropyl carbonate; and a carboxylic acid ester, such as methyl acetate, ethyl acetate, propyl acetate, methyl propionate, ethyl propionate, or γ-butyrolactone.

As examples of the above ether, for example, there may be mentioned a cyclic ether, such as 1,3-dioxolane, tetrahydrofuran, 2-methyltetrahydrofuran, propylene oxide, 1,2-butylene oxide, 1,3-dioxane, furan, or 1,8-cineol; and a chain ether, such as 1,2-dimethoxyethane, ethyl vinyl ether, ethyl phenyl ether, 1,2-diethoxyethane, 1,2-butoxyethane, diethylene glycol dimethyl ether, 1,1-dimethoxymetahne, 1,1-diethoxyethane, or triethylene glycol dimethyl ether.

As the nonaqueous solvent, among the solvents mentioned above by way of example, at least a cyclic carbonate is preferably used, and a cyclic carbonate and a chain carbonate are more preferably used in combination. In addition, as the nonaqueous solvent, a halogen-substituted compound formed by substituting a hydrogen atom of each of various types of solvents with a halogen atom, such as fluorine, may also be used. The nonaqueous solvent preferably contains vinylene carbonate or fluoroethylene carbonate.

The electrolyte salt is preferably a lithium salt. As examples of the lithium salt, for example, LiPF₆, LiBF₄, LiAsF₆, LiN(SO₂CF₃)₂, LiN(SO₂CF₅)₂, and LiPF₆₋ₓ(CₙF₂ₙ₊₁)ₓ (1<x<6, and n indicates 1 or 2) may be mentioned. As the lithium salt, those salts mentioned above may be used alone, or at least two types thereof may be used in combination. The concentration of the lithium salt is preferably set to 0.8 to 1.8 moles per one liter of the nonaqueous solvent.

### Separator

For the separator, a porous sheet having ion permeability and insulating properties is used. As particular examples of the porous sheet, for example, a fine porous thin film, a woven cloth, and a nonwoven cloth may be mentioned. As a material for the separator, a polyolefin, such as a polyethylene or a polypropylene, is preferable.

### EXAMPLES

Hereinafter, although the present invention will be further described with reference to examples, the present invention is not limited thereto.

### Experiment 1

### [Formation of Positive Electrode]

Lithium cobaltate, acetylene black, and a poly(vinylidene fluoride) were mixed together at a mass ratio of 95: 2.5: 2.5 and were then added to N-methyl-pyrrolidone (NMP). This mixture was stirred by a mixing machine (manufactured by PRIMIX Corp., T. K. HIVIS MIX), so that a slurry for forming a positive electrode mixture layer was prepared. The slurry thus prepared was applied to two surfaces of aluminum foil, dried in the air at 105° C., and then rolled, so that a positive electrode was formed. A packing density of the positive electrode mixture layer was 3.6 g/ml.

### [Formation of Negative Electrode]

After SiOₓ (x=0.93) having an average primary particle diameter of 5.0 μm was prepared, the surface thereof was covered with a film formed by a thermal CVD method using methane so as to have a carbon coverage of 5% with respect to the SiOₓ surface. This SiOₓ and graphite were mixed together at a mass ratio of 5: 95, and this mixture was used as a negative electrode active material. This negative electrode active material, a carboxymethyl cellulose (CMC, manufactured by Daicel FineChem Ltd., #1380, degree of etherification: 1.0 to 1.5), and a SBR were mixed together to obtain a mass ratio of 97.5: 1.0: 1.5, and water functioning as a diluent solvent was added thereto. This mixture thus formed was stirred by a mixing machine (manufactured by PRIMIX Corp., T. K. HIVIS MIX), so that a slurry for forming a negative electrode mixture layer was prepared. The slurry described above was applied to two surfaces of copper foil, dried in the air at 105° C., and then rolled, so that a negative electrode was formed. A packing density of the negative electrode mixture layer was 1.60 g/ml.

### [Preparation of Nonaqueous Electrolyte Solution]

Lithium hexafluorophosphate represented by LiPF₆ was added to a mixed solvent obtained by mixing ethylene carbonate (EC) and diethylene carbonate (DEC) at a volume ratio of 3: 7 to have a concentration of 1.0 mole/liter, so that a nonaqueous electrolyte solution was prepared.

### [Formation of Battery C1]

Tabs were fitted to the respective electrodes described above, and the positive electrode and the negative electrode were spirally wound with at least one separator interposed therebetween to form a wound electrode body so that the tabs were located at the outermost circumference portion. After the electrode body thus formed was inserted into an exterior package formed of an aluminum laminate sheet and was then vacuum-dried at 105° C. for 2 hours, the nonaqueous electrolyte solution described above was charged in the exterior package, and an opening portion thereof was sealed, so that a battery C1 was formed. A designed capacity of the battery C1 was 800 mAh.

### Experiment 2

Except that SiOₓ (x=0.93) having an average primary particle diameter of 1.0 μm was used, and the film formation was performed so that the carbon coverage with respect to the SiOₓ surface was 50%, a battery C2 was formed by a method similar to that of Experiment 1.

### Experiment 3

Except that 10 percent by mass of coal pitch was added to SiOₓ, and the film formation was performed by a heat treatment at 800° C. for 2 hours so that the carbon coverage with respect to the SiOₓ surface was 50%, a battery C3 was formed by a method similar to that of Experiment 1.

### Experiment 4

Except that the film formation was performed so that the carbon coverage with respect to the SiOₓ surface was 50%, a battery C4 was formed by a method similar to that of Experiment 1.

### Experiment 5

Except that SiOₓ (x=0.93) having an average primary particle diameter of 20 μm was used, and the film formation was performed so that the carbon coverage with respect to the SiOₓ surface was 50%, a battery C5 was formed by a method similar to that of Experiment 1.

### Experiment 6

Except that the film formation was performed so that the carbon coverage with respect to the SiOₓ surface was 80%, a battery C6 was formed by a method similar to that of Experiment 1.

### Experiment 7

Except that no carbon coating was performed on the SiOₓ surface, a battery R1 was formed by a method similar to that of Experiment 1.

### Experiment 8

Except that the film formation was performed so that the carbon coverage with respect to the SiOₓ surface was 100%, a battery R2 was formed by a method similar to that of Experiment 1.

### Experiment 9

Except that SiOₓ (x=0.93) having an average primary particle diameter of 1.0 μm was used, and the film formation was performed so that the carbon coverage with respect to the SiOₓ surface was 100%, a battery R3 was formed by a method similar to that of Experiment 1.

### Experiment 10

Except that SiOₓ (x=0.93) having an average primary particle diameter of 20 μm was used, and the film formation was performed so that the carbon coverage with respect to the SiOₓ surface was 100%, a battery R4 was formed by a method similar to that of Experiment 1.

### <Evaluation of Battery Performance>

Evaluation of cycle characteristics was performed on each of the batteries C1 to C6 and R1 to R4, and the results thereof are shown in Table 1.

### [Cycle Test]

Charge: A constant current charge was performed at a current of 1.0 It until the voltage reached 4.2 V, and subsequently, a constant voltage charge was performed at a voltage of 4.2 V until the current reached 0.05 It.
Discharge: A constant current discharge was performed at a current of 1.0 It until the voltage reached 2.75 V.
Rest: A rest time between the charge and the discharge was set to 10 minutes.

The number of cycles at which the discharge capacity reached 80% of that at a first cycle was measured as a cycle life. In addition, the cycle life is represented by the index calculated based on the assumption that the cycle life of the battery C4 is 100.

### <Zₐ and Zₐ/R>

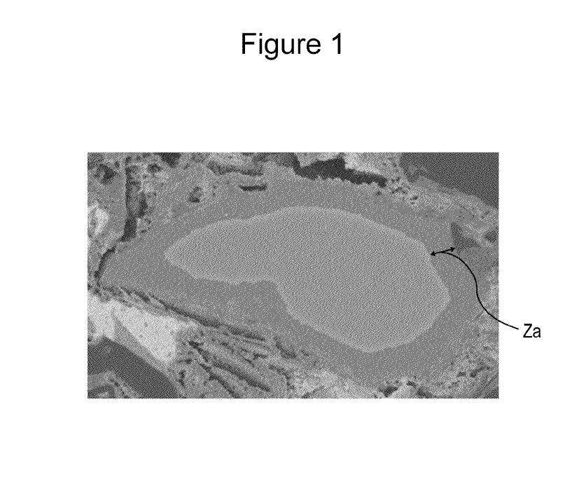

In an inert atmosphere, after batteries processed by 25 cycles and 100 cycles were each disassembled, the negative electrode was cut using an ion milling machine, and the cut surface was observed by a SEM. In addition, by performing a composition analysis using EDS, an O/Si ratio (xₛ) in the vicinity of the SiOₓ surface and an O/Si ratio (x_{b}) in the vicinity of the center were measured, and the distance from the surface to a point at which x=(xₛ+x_{b})/2 held was represented by zₐ (μm). In addition, the average particle diameter (D₅₀) measured by a laser diffraction scattering method was represented by R (μm), and the value of zₐ/R was calculated. In addition, a cross-sectional SEM image of the negative electrode of the battery C4 is shown in FIG. 1.

TABLE 1

| | 25 cycles | | | | Carbon | |
|---|---|---|---|---|---|---|
| | | zₐ | R | 100 cycles | coverage | Cycle |
| | zₐ/R | (μm) | (μm) | zₐ/R | (%) | life |
| R1 | 0.45 | 2.25 | 5.0 | Not | 0 | 21 |
| | | | | measured | | |
| C1 | 0.4 | 2.0 | 5.0 | 0.4 | 5 | 61 |
| C2 | 0.3 | 0.3 | 1.0 | 0.3 | 50 | 89 |
| C3 | 0.1 | 0.5 | 5.0 | Not | 50 | 128 |
| | | | | measured | (Coal | |
| | | | | | pitch | |
| | | | | | method) | |
| C4 | 0.05 | 0.25 | 5.0 | Not | 50 | 100 |
| | | | | measured | | |
| C5 | 0.025 | 0.5 | 20 | 0.03 | 50 | 82 |
| C6 | 0.025 | 0.125 | 5.0 | Not | 80 | 59 |
| | | | | measured | | |
| R2 | — | Uniform | 5.0 | — | 100 | 43 |
| | (Uniform | composition | | (Uniform | | |
| | composition) | | | composition) | | |
| R3 | — | Uniform | 1.0 | — | 100 | 39 |
| | (Uniform | composition | | (Uniform | | |
| | composition) | | | composition) | | |
| R4 | — | Uniform | 20 | — | 100 | 41 |
| | (Uniform | composition | | (Uniform | | |
| | composition) | | | composition) | | |

As apparent from Table 1, in the batteries C1 to C6 in which zₐ/R satisfied 0.025 to 0.4, the cycle life was improved as compared to that of each of the batteries R1 to R4. The cycle life of the battery C4 was 250 cycles.

The oxygen concentration of the surface layer of SiOₓ (after 25 cycles) used in each of the batteries C1 to C6 was higher than the oxygen concentration (intraparticle uniform concentration) of SiOₓ (after 25 cycles) used in each of the batteries R2 to R4. That is, it is believed that the amount of active Si of the surface layer of SiOₓ (after 25 cycles) used in each of the batteries C1 to C6 was smaller than that of the surface of SiOₓ (after 25 cycles) used in each of the batteries R2 to R4. Accordingly, it is believed that since a reaction between the active Si of the SiOₓ surface and the electrolyte solution was not likely to occur, and a side reaction product was also not likely to be deposited, the cycle life of each of the batteries C1 to C6 was improved.

The presence of a lithium silicate phase in the surface layer of SiOₓ (after 25 cycles) used in each of the batteries C1 to C6 was confirmed by an Auger electron spectroscopic method. The reason the cycle life of each of the batteries C1 to C6 was improved is believed that since the lithium silicate phase was generated in the surface layer of SiOₓ, the reaction between SiOₓ and the electrolyte solution was further suppressed, and the side reaction product was further not likely to be deposited.

The oxygen concentration of the surface layer of SiOₓ (after 25 cycles) used in each of the batteries C1 to C6 was lower than the oxygen concentration of the surface layer of SiOₓ (after 25 cycles) used in the battery R1. That is, it is believed that the amount of active Si of the surface layer of SiOₓ (after 25 cycles) used in each of the batteries C1 to C6 was larger than that of the surface of SiOₓ (after 25 cycles) used in the battery R1. In spite of the oxygen concentration described above, the reason the cycle life of the battery R1 was seriously degraded as compared to that of each of the batteries C1 to C6 is believed that since oxidation of Si excessively proceeded in the surface of SiOₓ, the decrease in capacity of the active material itself occurred with the progress of cycles.

In addition, although zₐ and R of SiOₓ used in each of the batteries C1, C2, and C6 tended to increase after 100 cycles as compared to those of SiOₓ after 25 cycles, the value of zₐ/R was not so much changed.

Although the cycle test of each of the batteries C1 to C6 and R1 to R4 was performed under the conditions described above, it is believed that as long as a cycle test is performed under charge/discharge conditions which have been commonly known, results equivalent to those shown in Table 1 are obtained. That is, it is believed that when the constant current in charge/discharge is set to 0.2 to 20 It, the charge final voltage is set to 4.2 to 4.7 V, and the discharge final voltage is set to 2.0 to 3.1 V, results equivalent to those shown in Table 1 can be obtained.

### Experiment 11

Except that the film formation was performed so that the carbon coverage with respect to the SiOₓ surface was 50%, and 2 percent by mass of vinylene carbonate was added to the nonaqueous electrolyte solution, a battery C7 was formed by a method similar to that of Experiment 1.

### Experiment 12

Except that the film formation was performed so that the carbon coverage with respect to the SiOₓ surface was 50%, and 2 percent by mass of fluoroethylene carbonate was added to the nonaqueous electrolyte solution, a battery C8 was formed by a method similar to that of Experiment 1.

### <Evaluation of Battery Performance>

The evaluation of cycle characteristics described above was performed on each of the batteries C7 and C8, and the results thereof are shown in Table 2.

TABLE 2

| | 25 cycles | | | Carbon | |
|---|---|---|---|---|---|
| | | Zₐ | R | coverage | |
| | zₐ/R | (μm) | (μm) | (%) | Cycle life |
| C4 | 0.05 | 0.25 | 5.0 | 50 | 100 |
| C7 | 0.04 | 0.2 | 5.0 | 50 | 112 |
| C8 | 0.035 | 0.175 | 5.0 | 50 | 123 |

As apparent from Table 2, when the electrolyte solution contains a vinylene carbonate or fluoroethylene carbonate, the cycle life is improved. The reason for this is believed that since a dense film is formed on the SiOₓsurface, the reaction between the surface of SiOₓand the electrolyte solution and the reaction between the carbon covering the SiOₓsurface and the electrolyte solution are suppressed, and as a result, the side reaction product are suppressed from being produced and deposited.

1. A nonaqueous electrolyte secondary battery comprising: a negative electrode active material which comprises a substance represented by a general formula of SiOₓ (0<x<2),
wherein when the value of x in the general formula is represented by xₛ at a surface of the substance and is represented by x_{b} at a central portion thereof, x_{b}<xₛ is satisfied, and
when a depth of the substance from the outside of the surface thereof at which x=(xₛ+x_{b})/2 is satisfied is represented by zₐ (μm), and an average particle diameter of the substance is represented by R (μm), 0.05<zₐ and 0.025≦zₐ/R≦0.4 is satisfied.

2. The nonaqueous electrolyte secondary battery according to claim 1,
wherein the surface of the substance is covered with an electron conductive material,
the coverage of the electron conductive material with respect to the surface of the substance is less than 100%, and
the electron conductive material is adhered to the surface of the substance.

3. The nonaqueous electrolyte secondary battery according to claim 2, wherein the coverage of the electron conductive material with respect to the surface of the substance is 5% to 80%.

4. The nonaqueous electrolyte secondary battery according to claim 1, wherein a region from the surface of the substance to zₐ includes a lithium silicate phase.

5. The nonaqueous electrolyte secondary battery according to claim 1,
wherein zₐ is 0.1 to 20 μm.

6. The nonaqueous electrolyte secondary battery according to claim 1,
wherein zₐ is 0.25 to 10 μm.

7. The nonaqueous electrolyte secondary battery according to claim 1,
wherein zₐ is 0.5 to 5.0 μm.

8. The nonaqueous electrolyte secondary battery according to claim 1, wherein the negative electrode active material further comprises carbon.
